(19) United States
(12) Patent Application Publication
(10) Pub. No.: US 2010/0224474 A1
(43) Pub. Date: Sep. 9, 2010

(54) RECYCLABE DOME SHEET ARRAYS

(75) Inventor: Peter Andrew Jeffery, Huntington Beach, CA (US)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Newton, MA (US)

(21) Appl. No.: 12/716,919

(22) Filed: Mar. 3, 2010

Related U.S. Application Data
(60) Provisional application No. 61/156,910, filed on Mar. 3, 2009.

(51) Int. Cl. H01H 1/10

(52) U.S. Cl. 200/512

(57) ABSTRACT

A moveable contact body that includes a carrier sheet, a moveable contact, and an adhesive layer on at least a portion of a lower surface of the carrier sheet and an upper surface of the moveable contact. The adhesive layer may be water soluble or viscoelastic. A viscoelastic material may be positioned on an upper surface of the carrier film. At least a periphery of the moveable contact may be a rolled foot. Another embodiment may be a membrane switch including a carrier sheet, a moveable contact and an electrical contact having a central stationary damping conductive pill.

### RELATED APPLICATION AND CLAIM OF PRIORITY

This application claims the priority of U.S. Provisional Application No. 61/156,910, titled “Recyclable Dome Sheet Arrays,” filed Mar. 3, 2009, the contents of which is hereby incorporated by reference in its entirety.

NOT APPLICABLE

### BACKGROUND

Dome arrays are sheets that carry dome-shaped moveable contacts. They may be used to function as switches of, for example, mobile phones and electric home appliances. The dome array is often a cost-effective solution for a simple switch that allows for a superior tactile interface between a user's equipment and the user. Compared to a membrane polyester switch or a poly dome sheet which were formerly used, dome array sheets provide better tactile properties and have a longer lasting life span. However, with such advances in dome array sheets, there is a need to find ways to provide high performance dome array sheets that may be reused or recycled. Additionally there is a need to provide moveable contacts with noise reduction mechanisms and/or are quiet touch moveable contacts.

### SUMMARY

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

An embodiment may be directed to a recyclable dome array sheet. The recyclable dome array sheet may include a carrier sheet, a plurality of moveable contacts and a water soluble adhesive on at least a portion of a lower surface of the carrier sheet and an upper surface of the plurality of moveable contacts. Upon placing the recyclable dome array sheet in a water-based solution, the water soluble adhesive may disassociate, disband or dissolve, thereby allowing the plurality of moveable contacts to separate from the carrier sheet. The plurality of moveable contacts and the carrier sheet may be recovered separately and then recycled. In an embodiment, a water resistant adhesive may be located around at least a portion of an external perimeter of the dome array sheet. In embodiments, the water resistant adhesive may be located around the complete perimeter of the dome array sheet. The water resistant material assists in preserving the environmental performance and integrity of the switch, from factors such as high temperature and humidity.

Another embodiment may be directed to a moveable contact body. The moveable contact body may include a carrier sheet, a moveable contact and an adhesive on at least a portion of a lower surface of a carrier sheet and an upper surface of the moveable contact. The adhesive may be a water soluble, a water dispersible pressure sensitive adhesive, a viscoelastic adhesive or a damping material. The moveable contact body may also include a viscoelastic material on an upper surface of the carrier sheet. At least a portion of a periphery of the moveable contact may be a rolled foot.

Another embodiment may be a membrane switch, including a carrier sheet, a moveable contact, an adhesive layer and an electrical contact. The electrical contact may have a central stationary damping conductive pill. The damping conductive pill may be made of a compliant material. The conductive pill may be a carbon pill or may be of any other conductive material. The carbon pill may further include a soft silicone material, an elastomer or a similar rubber material.

Another embodiment may be a membrane switch with a number of damping mechanisms. The membrane switch may include a carrier sheet, a moveable contact, an adhesive layer, a damping material, and an electrical contact. The damping material may be a viscoelastic material. The adhesive layer may be positioned over an upper layer of the moveable contact and a lower surface of the carrier sheet. The viscoelastic material may be positioned on an upper surface of the carrier sheet. At least a portion of a periphery of the moveable contact may be a rolled foot. Another manner in which to provide noise reduction may be to utilize a central stationary electrical contact of a conductive pill, such as a carbon pill with a damping material located thereon. The damping material on the carbon pill may be a silicone material. In other embodiments, the moveable contact may include additional layers of materials, for example alternating layers of a damping material and a film.

### BRIEF DESCRIPTION OF THE DRAWINGS

FIG. 1 illustrates a sectional view of an exemplary membrane switch dome-shaped moveable contact body according to an embodiment.

FIG. 2 illustrates a sectional view of an exemplary membrane switch according to an embodiment.

FIG. 3 illustrates a sectional view of an exemplary membrane switch according to an embodiment.

FIG. 4 illustrates a sectional view of an exemplary membrane switch according to an embodiment.

FIG. 5 illustrates a sectional view of an exemplary membrane switch according to an embodiment.

FIG. 6 illustrates a sectional view of an exemplary membrane switch according to an embodiment.

FIG. 7 illustrates an exemplary measured sound waveform produced by a comparative moveable contact according to an embodiment.

FIG. 8 illustrates an exemplary measured sound waveform produced by a moveable contact of the invention according to an embodiment.

### DETAILED DESCRIPTION

For purposes of the discussion below, the term “adhesive” refers to a compound that binds one object to a second object, either permanently, temporarily, or in a manner that will allow the objects to be separated.

The term “light guide” refers to a sheet of material that receives light from an external source, propagates light from the point of entry throughout the sheet, and distributes light so that light is provided over the surface area of the sheet.

The terms “positioned over” and “positioned under” define a location based relationship between two objects. The term “positioned over” includes positioned above, positioned next to, and positioned below. Similarly, the term “positioned under” includes positioned above, positioned next to, and positioned below. For example, if item X has object A positioned above object B, object A is still positioned above object B if item X is turned upside down or if item X is turned on its side.

The invention is generally directed to membrane switches. In particular the invention is directed to recyclable dome array sheets and to quiet touch movable contacts.

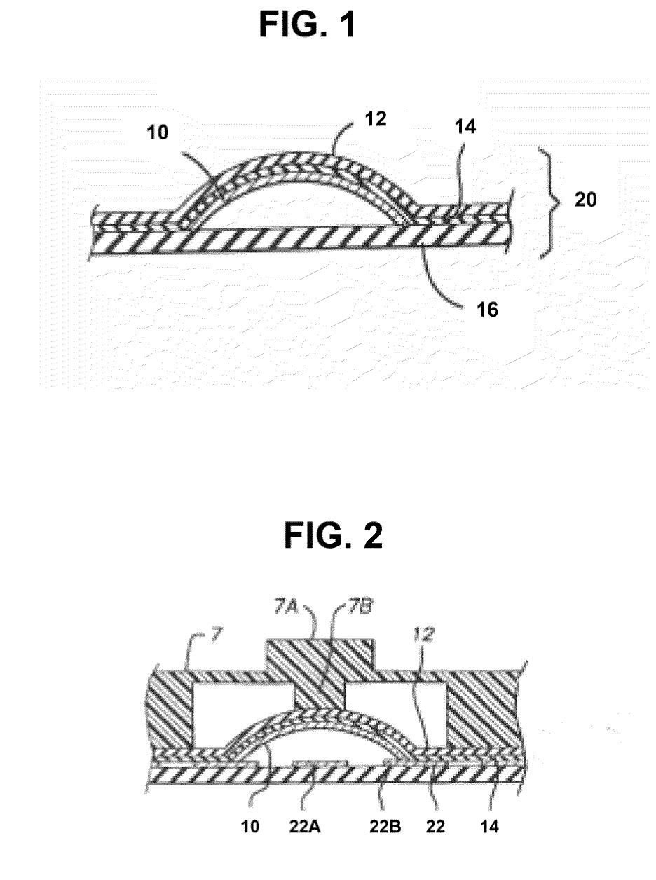

FIG. 1 illustrates an exemplary membrane switch dome-shaped moveable contact body 20. While the description herein may refer to the moveable contact body or moveable contact as being dome shaped, it is not meant to be limiting, as the moveable contact may be any shape such as oblong, triangular, trapezoidal, and the like. In other configurations, the moveable contact may be any shape having an elevated or raised portion.

The membrane switch dome-shaped moveable contact body 20 includes a dome-shaped moveable contact 10, a flexible carrier sheet 12 and an adhesive layer 14 positioned or located on or between a lower surface of the carrier sheet 12 and an upper surface of the moveable contact 10. The moveable contact 10 may be secured to the carrier sheet 12 with the adhesive layer 14 in such a manner that the upwardly curved upper surface of the moveable contact may be covered with the carrier sheet 12.

A separator 16 may also be present as illustrated in FIG. 1. Separator 16 may be made of paper, insulating film or may be the carrier film, and be may used to protect the dome-shaped moveable contact. The separator may also prevent corrosion of the dome-shaped moveable contact by gasses in air or the sticking of foreign matters thereto. The separator 16 may be bonded to the lower surface of the carrier sheet 12 with the adhesive layer 14 to close the opening of the dome-shaped moveable contact, thereby forming the membrane switch moveable contact body 20.

As stated above, the moveable contact may be of any shape, preferably having a raised portion, such as a dome-shape. The moveable contact may be a thin, elastic metal plate. In an embodiment, the moveable contact may be an alloy or composite material. Alternatively, the moveable contact may be made of the same metal as the movable contact body or a material which in turn aids in reducing material cost associated with the use of additional precious metals. In other embodiments, the dome-shaped movable contact may be stainless steel, aluminum, or any other material that may be easily recyclable as well as eco-friendly. In other embodiments the stainless steel may be plated with another conductive material, such as nickel, silver, gold and the like. Preferably the material selected decreases manufacturing costs, for example costs associated with monitoring and controlling chemical discharge during a plating process.

The carrier sheet 12 may be a bio-plastic carrier sheet, for example a polyethylene terephthalate (PET) sheet. The sheet may be an electrically insulating material, or a conductive material to form an electrostatic discharge (ESD) shield, or alternatively a combination of both, part electrically insulating and part ESD shield. In alternate embodiments, carrier sheet 12 may be a light guide made up of a flexible material such as polycarbonate.

The recyclable dome array sheet may utilize a water soluble, dispersive, dissolvable or dissipateable adhesive or a water soluble pressure sensitive adhesive. The water soluble adhesive allows for an unobtrusive manner by which to separate the moveable contact 10 from the carrier sheet 12, thereby allowing either or both parts to be recycled. In an embodiment, a used dome array sheet having multiple dome-shaped moveable contacts on for example a carrier sheet, may be recycled to separate the moveable contacts from the carrier sheet. This may be done by, for example, a water based separation process, which allows the water soluble adhesive to disassociate, thereby allowing the dome-shaped moveable contacts to separate or debond from the carrier sheet. The dome shaped moveable contacts and the carrier sheet may then be easily recovered and recycled for future use.

Examples of water soluble, water dissolvable, water dissipateable or water dispersible pressure sensitive adhesives include for example water soluble polyether polyols and water soluble base polymers such as polyacrylates containing sulfonic acid salt groups and the like. Other systems may include for example, a water soluble system based on polymethyl methacrylate plasticized with polyethylene glycol, polyethylene oxide, or various polymers (such as PolyOx® water soluble resins), or a dispersion of a thermoplastic acrylic polymer on the basis of methyl methacrylate and butyl acrylate, polyvinal pyrrolidenes, or dimethyl hydantoin formaldehyde resin, and the like.

The adhesive may be applied to at least a portion of the lower surface of the carrier sheet or an upper surface of the moveable contact or a combination thereof as described further herein. Additionally the adhesive may cover the entire surface area of the dome-shaped moveable contact or alternatively at least a portion thereof.

In an embodiment, a water resistant material adhesive may be located around at least a portion of an external perimeter or periphery of the dome array sheet. The water resistant adhesive alternatively may be located around a complete perimeter of the dome array sheet. The water resistant material assists in preserving the environmental performance and integrity of the switch, from variables such as high temperature and humidity. Examples of water resistant materials that may be used include adhesives comprising polyurethanes, polyvinyl chloride, 3M's UV Screen Printable Adhesives SP-7514 as well as KIWOPRINT® TC 2000 manufactured by KIWO, Inc., and the like.

In other embodiments, as mentioned above, a conductive film may be located or printed on the upper surface of the carrier sheet of a dome-shaped movable contact body. The conductive film may be used to ground static electricity produced during the operation of the membrane switch, for example, depressing an operating section of a push button. The conductive film may be attached by for example a silver-based or carbon-based paste.

FIG. 2 illustrate an exemplary membrane switch with a circuit board 22. A circuit board may include a single contact or a plurality of fixed contacts. Fixed contacts may be, but are not limited to electrical contacts. The moveable contact may be positioned over one or more fixed or centrally located electrical contacts. The moveable contact may then touch or come into contact with a fixed electrical contact when depressed as discussed herein.

In an embodiment, the contacts may be made of a conductive materials, such as a carbon paste pad. The use of a carbon paste pad eliminates the need for expensive elements, such as copper as well as processes that require etching chemicals, which in turn decreases manufacturing costs. Accordingly by utilizing a conductive pill or carbon pad, contact resistance may be increased. For example, the carbon pad may allow the contact resistance to be increased to about greater than 100 Ohms, or even greater than about 50,000 Ohms. Typical dome array designs for example, a silver plated dome over a gold plated contact pad may result in a contact resistance of less than 1 Ohm. Accordingly by using a carbon pad as described herein, the contact resistance is increased thereby reducing the current that flows through the contact for each keypress. This in turn acts to reduce the total energy consumed each time a key is pressed which in turn aids in increasing battery life.

FIG. 2 also illustrates a push button 7 above the membrane switch. The push button may be of a flexible rubber or resin. When an operating section 7A of the push button 7 is depressed, a depressing portion 7B formed on the lower surface of the operating section 7A may be caused to depress the moveable contact 10 through the carrier sheet 14. As a result, the movable contact 10 may perform reverse motion or itself depress, so that the central part thereof is brought into contact with the central stationary contact 22A. In other words the central stationary contact 22A of the circuit board 22 may be electrically connected to the outside stationary contact 22B. Upon release of the push button 7, the elastic restoring force of the moveable contact acts to disconnect the central part of the moveable contact from the central stationery contacts 22A, that is, the membrane switch is turned off. In other embodiments of push button 7, a depressing potion 7B may not be present and at least a portion of the lower surface of the operating section 7A may make contact with the moveable contact.

As discussed above in FIG. 2, circuit board 22 includes at least one central stationary contact 22A and outer stationary contacts 22B. In this embodiment, the separator (not shown) may be removed from the membrane switch moveable contact bodies 20, to form membrane switch movable contact bodies 20A. The membrane switch movable contact body 20A may be bonded to the circuit board 22 through the adhesive 14. In this embodiment, the adhesive layer may be provided on the lower surface of the carrier sheet in such a manner that an outer periphery of each of the dome-shaped moveable contacts may be on the respective outer stationary contact such that an upper most part or the top of the dome-shaped movable Contact may be confronted or in contact with the at least one central stationary contact 22A.

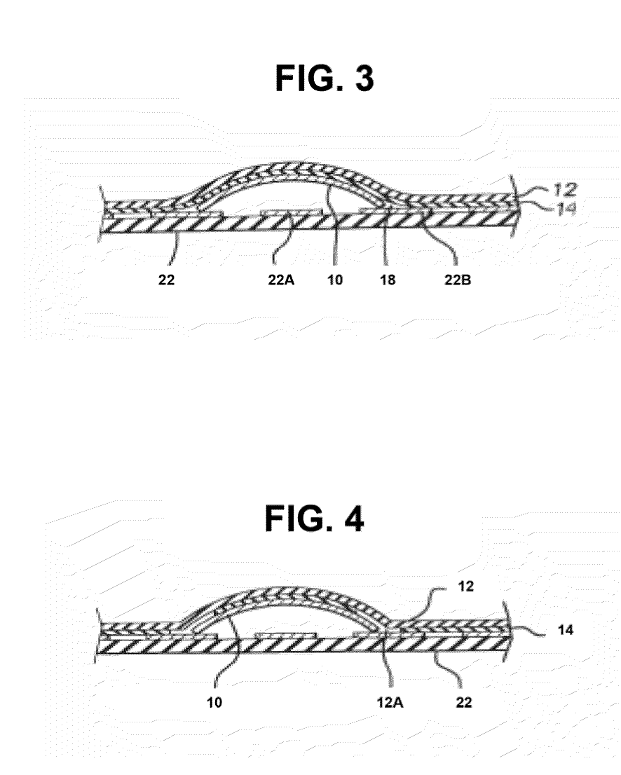

FIG. 3 is a sectional view of the membrane switch movable contact body of another embodiment. FIG. 3 illustrates an exemplary embodiment of a dome-shaped moveable contact 10 covered with carrier sheet 12, and bonded to the sheet in such a manner that a peripheral edge of the movable contact 10 may be spaced from the adhesive 14 of the carrier sheet 12 to form a gap 18. Gap 18 may be formed between the peripheral edge of the dome-shaped movable contact 10 and the bonding surface of the carrier sheet 12. This construction prevents entrance of the adhesive agent 14 into the movable contact 10 along the peripheral edge of the moveable contact, and eliminates the difficulty that the movable contact may be interrupted from being brought into contact with the central stationary contact 22A and the outside stationary contact 22B. Additionally, converse to an embodiment where the upwardly curved upper surface of the movable contact may be covered with a carrier sheet in its entirety, the reverse motion of the movable contact preferably, may not be obstructed by the carrier sheet. This in turn allows for the membrane switch to be smoothly operated.

As indicated above, the adhesive layer 14 may be a continuous layer or alternatively may be a portion of the layer, or may be discontinuous, patterned, and the like. In an exemplary embodiment, FIG. 4 illustrates an embodiment where a portion of an adhesive layer 14 may be utilized. Carrier sheet 12 may have carrier sheet-exposed sections 12A (where no adhesive layer 14 has been applied) around the lower peripheral edge of the movable contact 10. This in turn assists in preventing the entrance of any portion of the adhesive layer 14 into the movable contact 10 along the peripheral edge of the moveable contact 10.

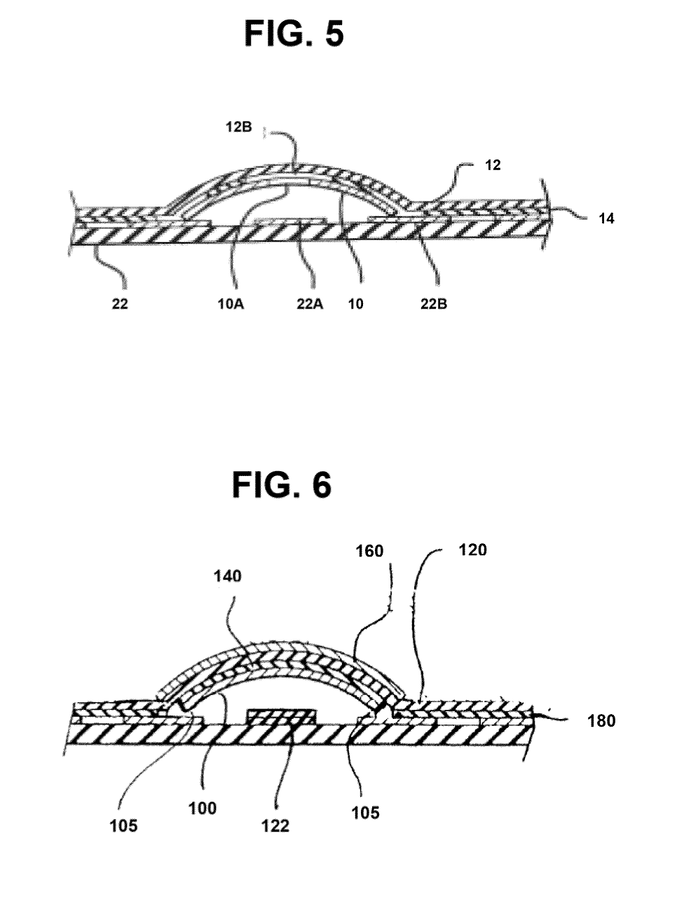

FIG. 5 illustrates an embodiment where a patterned adhesive layer configuration may be utilized as well as another configuration of the dome-shaped moveable contact. The top or upper most portion of a movable contact may have a hole 10A. A portion of the lower surface of the carrier sheet 14 which is around the hole 10A may be a carrier sheet exposed section 12B where no adhesive layer 14 may be applied.

A membrane switch formed with this configuration of the movable contact body may functions as follows. In this embodiment, the peripheral edge of the small hole 10A formed in the top of the movable contact 10 may be brought into contact with the central stationary contact 22A. This allows the movable contact to be more positively brought into contact with the central stationary contact 22A. Additionally, the part of the lower surface of the carrier sheet 12 which is around the small hole 10A of the movable contact 10, is not coated with the adhesive layer 14; that is, the part is employed as a carrier sheet exposed section 12B. Therefore, the entrance of the adhesive layer 14 into the movable contact 10 through the small hole 10A may be prevented.

The invention is also directed to a quiet touch moveable contact. In an embodiment, the moveable contact may include additional layers to significantly reduce a clicking noise while preserving the tactile feel of a membrane switch, which is typically observed by a force and displacement curve. An exemplary embodiment of a quiet touch moveable contact is illustrated in FIG. 6. In particular, FIG. 6 illustrates three mechanisms in which a moveable contact may be modified to increase damping of the clicking sound for example. Each method described herein may be utilized alone or in combination with various other methods, up to and including use of all three methods discussed above, to achieve a quiet touch moveable contact.

The moveable contact in FIG. 6 includes a dome-shaped moveable contact 100, a carrier sheet 120, and an adhesive layer 140 between the lower surface of the carrier sheet and an upper surface of the dome-shaped moveable contact. The moveable contact 100 may include at least one damping layer 160 on a top surface of the carrier sheet 120.

The adhesive layer 140 may be any type of adhesive. In an embodiment the adhesive may be a damping or a vibration absorbing polymer adhesive. For example, it may be an acrylic based viscoelastic adhesive. Examples include acrylic adhesives, silicone adhesives, epoxy adhesives, phenolic adhesives, acrylic-epoxy blends, thermoplastic polyimide adhesive, phenolic adhesives blended with nitrile rubbers, and the like. In an alternate embodiment, the adhesive layer may be any of the adhesives discussed earlier above.

The at least one damping layer 160 may be a damping material or viscoelastic material. The viscoelastic material may include an elastomer, adhesive or plastic. Such materials may be acrylic polymers, ultra-pure polymers, liquid silicone rubbers, and the like. These materials may provide damping in ranges of temperatures as low as 0° C. to as high 105° C. Examples of damping materials include for example, plastic constraining material that may be moldable at ambient temperature. Examples of viscoelastic materials may include polyolefins and vinyl chloride resins, petroleum resin, polybutadiene, isocyanate, rubber, filler and mixtures thereof, include acrylic rubber, butyl rubber, nitrile rubber, natural rubber, fluorosilicone rubber, fluorocarbon rubber, polyethylene, polymethyl methacralate silicone rubber, polyimide, polyether sulphone, polyetherimide, polytetrafluoroethylene, polyesters, polyethylene naphthalene and the like.

The damping layer preferably 160 includes material having a loss factor as a function of frequency that is greater than about 0.01. As another example, the viscoelastic structure may have a loss factor that may be greater than about 1.0 or 1.5. The viscoelastic structure may also have a loss factor that may be greater than about 2.0.

As illustrated in FIG. 6, a separator 180 may also be used. Separator 180 preferably may be a vibration absorbing or damping material. In other embodiments, separator 180 may be a damping adhesive, a viscoelastic material and the like.

In other embodiments, additional layers of damping materials to form for example an acoustic layered configuration similar to a sandwich-type configuration may be utilized. For example there may a configuration of at least a damping material, a thin film and an adhesive therebetween. While this configuration is described therein, it is not meant to be limiting, and it is understood that any other material or configuration may be utilized. The thin film may be a film such as a PET film and may be about 25 μm-about 50 μm. An adhesive, such as a damping adhesive may be located on an upper surface of the damping material and a lower surface of the film. The acoustic layer configuration may include multiple repeating units of for example, a damping material, an adhesive, and a film. In other embodiments, there may be a single acoustic layer configuration or alternatively the addition of other layers or configurations in the acoustic layer configuration.

The acoustic layered configuration may be located on the carrier sheet. In an embodiment the acoustic layered configuration may cover at least a portion of the carrier sheet. In other embodiments, the acoustic layered configuration may surround a circumference or outer rim or periphery of the dome-shaped moveable contact. In other embodiments, the acoustic layered configuration may be on a portion of the dome-shaped moveable contact and may surround a portion of the outer periphery of the dome-shaped moveable contact.

To further decrease the sound and increase damping of the moveable contact, a conductive pill, such as a carbon pill 122 may be utilized. The carbon pill may also include a damping material, flexible material or polymer to further aid in damping while preserving electrical conductivity properties of the pill. For example, the carbon pill may include a soft silicone covering or coating, or may even be co-molded with another material. In an embodiment, at least a central portion of the conductive pill may be compliant, for example a carbon loaded silicone rubber material. Factors in selecting a material to increase damping, include for example polymer loss factor, density and geometry.

In an embodiment at least one peripheral edge 105 of the moveable contact may be a shape. For example, as illustrated in FIG. 6, opposite peripheries of the moveable contact 100 may be a rolled foot. The rolled foot may be on one side or on both ends. The rolled foots act to reduce vibrations and accordingly absorb sound. Any other shapes for example on as a designated area, preferably on the periphery of moveable contact may be utilized or modified to absorb sound waves.

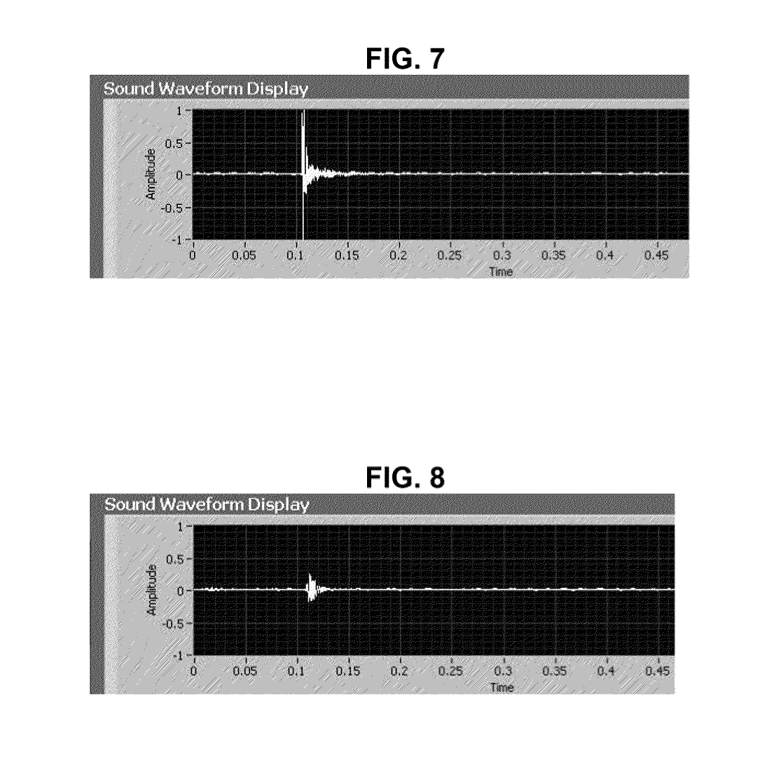

FIG. 7 illustrates sound waveforms resulting from an exemplary embodiment of a standard moveable contact having a dome, adhesive, and sheet configuration.

FIG. 8 illustrates waveform from an exemplary embodiment of a moveable contact of the invention. In particular, this includes a soft, compliant, sound absorbing central PCB pad and the added visco-elastic acoustic material. In this sound waveform it can be see that the volume or rather amplitude is substantially lower than the amplitude resulting from the standard moveable contact in FIG. 7. Additionally, the duration of sound of the moveable contact of the invention is shorter and almost virtually silent in a typical application.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A moveable contact body, comprising:
a carrier sheet;
a moveable contact; and
an adhesive layer on at least a portion of a lower surface of the carrier sheet and an upper surface of the moveable contact.

2. The moveable contact body according to claim 1, wherein the adhesive layer is water soluble.

3. The moveable contact body according to claim 1, wherein the adhesive layer comprises a viscoelastic adhesive.

4. The moveable contact body according to claim 3, further comprising a viscoelastic layer on an upper surface of the carrier sheet.

5. The moveable contact body according to claim 3, wherein at least a portion of a periphery of the moveable contact is rolled foot.

6. The moveable contact body according to claim 1, wherein the adhesive layer has a loss factor of greater than about 0.01.

7. A recyclable dome array sheet comprising:
a carrier sheet;
a plurality of moveable contacts; and
a water soluble adhesive layer on at least a portion of a lower surface of the carrier sheet and an upper surface of the plurality of moveable contacts, wherein the plurality of moveable contacts are separated from the carrier sheet upon exposure to a water-based solution.

8. A membrane switch, comprising:
a carrier sheet;
a moveable contact; and
an electrical contact comprising a central stationary damping conductive pill.
